(19) United States
(12) Patent Application Publication
(10) Pub. No.: US 2012/0293432 A1
(43) Pub. Date: Nov. 22, 2012

(54) METHOD FOR TOUCH DEVICE TO TRANSMIT COORDINATES, METHOD FOR TOUCH DEVICE TO TRANSMIT DISPLACEMENT VECTOR AND COMPUTER-READABLE MEDIUM

(76) Inventor: Tsung-Hsien Wu, New Taipei City (TW)

(21) Appl. No.: 13/474,476

(22) Filed: May 17, 2012

(30) Foreign Application Priority Data
May 19, 2011 (TW) 100117655
Dec. 30, 2011 (TW) 100149892

(51) Int. Cl. G06F 3/041

(52) U.S. Cl. 345/173

(57) ABSTRACT

A method for a touch device to transmit coordinates is provided. In a multi-object operation, when a number of objects remains unchanged, the method reduce data to be transmitted by only transmitting displacement vectors of the objects that move.

### BACKGROUND OF THE INVENTION

1. Technical Field

The present invention is related generally to a touch device and, more particularly, to a method for a touch device to transmit coordinates.

2. Description of Related Art

Touch technology has been extensively used, and has been further enhanced by multi-finger touch and gesture touch. As an effective input means, touch input devices are structurally simpler and provide users with a more intuitive input operation as compared to the traditional input devices. However, when evolving from single-touch to multi-touch, one of the challenges to be conquered is the demanding data transmission requirements. In the case of single-touch, only a few bytes are enough for expressing the location of a finger on the touch device. Even for the applications where higher definition is required, several more bytes would be quite adequate. In the case of multi-touch, however, for expressing the full location information, the capacity has to be at least doubled because more fingers are involved. Referring to FIG. 1, when five fingers working on a touch device 10, the touch device 10 has to transmit five sets of location information, namely (X1,Y1), (X2,Y2), (X3,Y3), (X4,Y4) and (X5,Y5), for informing an external device (such as a host computer) of the locations of the five fingers. Assuming that it takes 2 bytes for the touch device 10 to transmit the location information of each finger, the data transmission for five fingers requires 2×5 bytes. Unfortunately, under a given transmission bandwidth, the larger the number of fingers is, the longer the data transmission takes.

Moreover, in detecting a finger's movement, a touch device uses the finger's coordinates in two successive scanning frames to determine the displacement vector of the finger. Since the touch device has limited scanning frequency and limited transmission speed, when processing multi-finger operation, it takes considerable time to calculate the displacement, being seen by the user as cursor pause or cursor lag. As shown in FIG. 2, for deriving the displacement vector (ΔX5,ΔY5) of fifth fingers from the coordinates (X5,Y5) and (X5,Y5)” in two successive scanning frames n and n+1, as it takes long time to transmit all the location information, during this period, the cursor is very likely to respond to the user's operation with pause, lag and/or jump.

### SUMMARY OF THE INVENTION

One objective of the present invention is to provide a method for transmitting coordinates by transmitting a displacement vector in a segmented manner transmission and also provide a computer-readable medium related thereto, so as to solve the foregoing problem.

According to the present invention, a method for a touch device to transmit coordinates comprises transmitting a status information when a number of objects contacting the touch device is changed, wherein the status information includes a head information of initial coordinates of each said object and a displacement vector information of at least one said object.

According to the present invention, a computer-readable medium stores a program code, and when the program code is executed by a processor, the processor's performance includes steps of: transmitting a status information when a number of objects contacting a touch device is changed, wherein the status information includes a head information of initial coordinates of each said object and a displacement vector information of at least one said object.

According to the present invention, a method for a touch device to transmit coordinates includes detecting initial coordinates and displacement vectors of a plurality of objects contacting the touch device, and transmitting the initial coordinates and the displacement vectors.

According to the present invention, a computer-readable medium stores a program code, and when the program code is executed by a processor, the processor's performance includes steps of: detecting initial coordinates and displacement vectors of a plurality of objects contacting the touch device, and transmitting the initial coordinates and the displacement vectors.

As compared to the prior art, the methods of present invention reducing data to be transmitted by merely transmitting displacement vectors, so as to reduce bandwidth waste and adapt given hardware to more additional applications.

### DETAILED DESCRIPTION OF THE INVENTION

For illustrating the present invention and highlighting its features, the following embodiments are related to a process where a touch device (such as a touch screen or a touch panel) is scanned to obtain electronic signals associated with fingers' coordinates, and then the coordinates are transmitted to a host computer as structured information. The electronic signals obtained in such a process can be generally sorted into three types, including (1) those corresponding to the fingers' touching the touch device, (2) those corresponding to the fingers' operating on the touch device, and (3) those corresponding to the fingers' leaving the touch device. In a preferred embodiment, for the method for transmitting coordinates, the processed electronic signals are encoded into three information blocks, namely a status information STATUS, a head information HEAD and a motion information MOTION. Therein, the status information STATUS is for expressing the number of fingers touching the touch device, and the head information HEAD is for expressing the locations where the fingers touch the touch device, while the motion information MOTION is for expressing displacement vectors of the fingers on the touch device.

In the embodiment of FIG. 3, the status information STATUS includes one number value FN and five status values F1˜F5. The number value FN represents the number of fingers touching the touch device, and the status value F1˜F5 represent the states of five fingers touching the touch device. For example, the first status value F1 represents the touching state of the first finger (for instance, value “1” for F1 meaning touch and “0” meaning non-touch), and the second status value F2 represents the touching state of the second finger, and so on. The order of the status values F1˜F5 and their connection with the fingers may be arranged differently. For example, it is possible to make F5 correspond to the first finger, F4 correspond to the second finger, and so on. The order of the fingers from the “first” to the “fifth” may be set according to the locations where the fingers contact. For instance, the order may be defined from the left to the right or from the bottom to the top, so that the finger having the most left or the most bottom contact point is defined as the first finger. Once again, the order of these fingers is defined solely according to the preference of the system designer, and forms no limitation to the present invention. The head information HEAD includes information about identification codes ID1˜ID5 and initial coordinates (or absolute coordinates) COD1˜COD5. The identification codes ID1˜ID5 correspond to the status values F1˜F5, respectively, and the initial coordinates COD1˜COD5 correspond to ID1˜ID5, respectively. In one embodiment, each of the initial coordinates COD1˜COD5 has an X coordinate and a Y coordinate that are each represented by one byte, so the coordinates in the range of 0-255 can be represented. However, this forms no limitation to the present invention and people skill in the art would be capable of implementing or modifying the present invention basing on the disclosure. For example, the use of two bytes allows representation for a broader range of coordinates. The motion information MOTION includes information about the aforementioned identification codes ID1˜ID5 and their corresponding displacement vectors Δ X1˜ΔX5 and ΔY1˜ΔY5. The displacement vector ΔX represents the displacement vector of the finger in a first direction X, and the displacement vector ΔY represents the displacement vector of the finger in a second direction Y.

According to the present invention, when the touch device transmits the coordinates, the three information blocks, i.e. the status information STATUS, the head information HEAD and the motion information MOTION, are transmitted to a host computer, such as a processor installed inside a laptop computer. The host computer learns from the status information STATUS about the number of the fingers touching the touch device, learns about the initial coordinates of the fingers' contact location from the head information HEAD, and learns from the identification code about to which finger the displacement vector in the motion information is corresponding, thereby obtaining the post-movement locations of the fingers on the touch device according to the displacement vectors and the initial coordinates.

For an example where two fingers contact the touch device, referring to FIG. 4, in the status information STATUS, the number value FN is set as 2, and both of F1 and F2 are set as 1, while all of F3˜F5 are set as 0. The head information HEAD provides the initial locations of the two fingers. The identification code ID1 is set as 1 for corresponding to the first finger, and COD1 related thereto provides the initial coordinates of the first finger. ID2 is set as 2 for corresponding to the second finger, and COD2 related thereto provides the initial coordinates of the second finger. In the motion information MOTION, the identical identification codes ID1 and ID2 are used to represent the first and second fingers, respectively. ΔX1 and ΔY1 related to the identification code ID1 represent the displacement vector of the first finger, while ΔX2 and ΔY2 related to the identification code ID2 represent the displacement vector of the second finger. The displacement vectors are related to the fingers' movement. If the first finger is detected as leaving, the status information STATUS is resent, with FN therein changed to be 1 for showing that there is only one finger touching the touch device, F1 changed to be 0, F2 remained as 1, the head information of ID1 held from transmission, and the head information of ID2 transmitted independent of ID1. In other words, if any of the fingers remains working on the touch device, the set order of the status values F1˜F5 and their connection to the respective fingers are held unchanged. Only the status value(s) related to the gone finger(s) will change, and the finger(s) remained will be still related to the same identification code(s). If there is an additional finger touching the touch device, the status value F3 will be changed to 1 for reflecting the presence of the finger newly coming into contact. In different embodiments, the status information STATUS may be reset according to the foregoing method, that is, according to the detected contact locations of the fingers, making the first finger relate to F1 and making the second finger relate to F2.

FIG. 5 is a flowchart a method 40 of one embodiment of the present invention. The method 40 for a touch device to transmit coordinates includes, without limitation, the following steps. In addition, as long as the substantially same results can be achieved, these steps may be performed in any order and are not necessarily performed in the order shown in FIG. 5. These steps are:

Step S400: Start;

Step S410: Scanning, where the touch device is scanned;

Step S420: Signal processing, where signals obtained from the scanning of Step S410 are processed to derive contact information containing the number of the finger(s), the location of each said finger on the touch device, and so on, wherein the processed signals are used as the basis of the following steps;

Step S430: Commencing transmission;

Step S440: Detecting whether the number of the finger(s) is changed, and if the detected number of the fingers is changed, conducting Step S460, or else conducting Step S450;

Step S450: Detecting whether the number of the finger(s) is 1, and if so, conducting Step S452, or else conducting Step S451;

Step S451: Determining gesture, where results of scanning are used to determine whether the operation of the finger(s) on the touch device forms a given gesture, and if so, conducting Step S454, or else conducting Step S453;

Step S452: Transmitting a head information, and then performing Step S470;

Step S453: Transmitting a motion information, which includes sorted displacement vectors, and then performing Step S470;

Step S454: Transmitting a motion information, and then performing Step S455;

Step S455: Determining whether all the displacement vectors related to the finger(s) are transmitted, and if so, conducting Step S470, or else conducting Step S454;

Step S460: Determining whether there is contact from any finger, and if so, conducting Step S461, or else conducting Step S462;

Step S461: Detecting whether the number of the finger(s) is 1, and if so, conducting Step S463, or else conducting Step S464;

Step S462: Transmitting a status information, and then performing Step S470;

Step S463: Transmitting a status information, and then performing Step S465;

Step S464: Transmitting a status information, and then performing Step S466;

Step S465: Transmitting the head information, and then performing Step S470;

Step S466: Transmitting the head information, and then performing Step S467;

Step S467: Determining whether all the displacement vectors related to the finger(s) are transmitted, and if so, conducting Step S470, or else conducting Step S466; and

Step S470: End of transmission;

In the flowchart of FIG. 5, a scanning frame includes the steps from “Scanning” to “End of transmission”. After the transmission ends in Step S470, the same steps, from Step S410 to Step S470, are repeated for the next scanning frame. Step S440 determines whether the number of the finger(s) is changed by comparing the numbers of fingers in the two successive scanning frames. The contact information containing the number of the finger(s), the contact location of each said finger on the touch device, and so on, as obtained in Step S420, is used to generate the status information and the head information while the displacement vectors of the fingers in the two successive scanning frames are used to generate the motion information.

Briefly, the method 40 for transmitting coordinates determines whether to transmit a new status information STATUS according to whether there is any change about the touching state of the finger(s) on the touch device in each scanning frame, or in other words, whether there is(are) finger(s) coming into contact or leaving. If it is confirmed that there is(are) finger(s) coming into contact or leaving, a new status information STATUS is to be sent. The major steps of FIG. 5 will be described in detailed below.

Step S450 involves determining whether it is a single-finger operation, and if so, conducting Step S452 where the head information HEAD is transmitting before the transmitting ends. That is to say, for a single-finger operation, only the coordinates of the single finger is transmitted and no displacement vector is transmitted.

In a case of multi-touch, Step S451 is performed to confirm where there is a gesture formed. If there is no gesture formed, Step S453 only transmits a single motion information MOTION that contains the sorted displacement vectors. It is worth noting that the motion information MOTION does not necessarily include the displacement vectors of all the fingers in contact, but may only contain the displacement vectors of the fingers that regarded as major. This will be discussed in detail later. If in Step S451, it is determined that the fingers' operation on the touch device forms a particular gesture, Steps S454 and S455 involve transmitting the motion information MOTION of every finger.

If it is determined in Step S440 that the number of the fingers is changed, it is further determined in Step S460 whether there is any finger in contact. If there is no finger contacting, the method enters Step S462 to transmit a new status information STATUS, and then ends the transmission, before being repeated for the next scanning frame. If one or more fingers are found in contact in Step S460, Step S461 is performed so as to further determine whether it is a single-finger operation. If so, Step S463 is performed for transmitting a new status information STATUS, and then Step S465 is performed for transmitting the head information HEAD. If it is a multi-finger operation, Step S464 is performed for transmitting a new status information STATUS, and then Step S466 and S467 involve transmitting the head information of each of the fingers.

As can be seen from the flowchart of FIG. 5, whether what newly comes into contact with the touch device is a single finger or multiple fingers, the status information and the head information are transmitted. In different embodiments, the status information and the head information may be packed into the same packet. In each of the following scanning frames, for a single-finger operation, only the head information is transmitted until the touching state changes, and for a multi-finger operation, only the motion information is transmitted until the touching state changes. In the present invention, a multi-finger operation requires merely the transmission of the motion information that contains the fingers' vector and does not lead to the transmission of the coordinates of all the fingers, so the data to be transmitted can be significantly reduced.

In Step S453, only a motion information is transmitted. The displacement vectors contained in the motion information have been sorted. FIG. 6 illustrates how to determine the order of the displacement vectors. A flow 50 for transmitting the motion information includes, without limitation, the following steps. In fact, as long as the substantially same results can be achieved, these steps may be performed in any order and are not necessarily performed in the order shown in FIG. 6. These steps are:

Step S500: Start;

Step S510: Calculating an acceleration information related to each finger according to a distance traveled by the finger;

Step S520: Determining a transmitting sequence SEQ of the fingers' displacement vectors according to the acceleration information;

Step S530: Transmitting the displacement vectors according to the transmitting sequence SEQ; and

Step S540: End.

Step S510 includes calculating a first distance traveled by each finger in a first scanning frame, and a second distance traveled each finger in a successive second scanning frame. Since the interval between the scanning frames is constant, a sum of the first distance and the second distance may be used to represent the magnitude of the acceleration of the finger. Therein, none of the distances is negative, meaning that the direction is not a factor considered. The distance traveled may be derived according to the equation below (a root of a sum of ΔX's square and ΔY's square):

Distance=(ΔX²+ΔY²)^{1/2}.

In addition, when a major finger is identified, and the rest of the fingers have their acceleration greater than a predetermined value A, it is determined that the user is forming a gesture. At this time, the motion information is transmitted in the way described in Step S454.

Afterward, Step S520 is performed for determining the transmitting sequence of the displacement vectors according to the acceleration information of each finger. The finger having the greatest acceleration is regarded as the major finger, while the others are defined as non-major fingers. The displacement vector of the major finger is transmitted preferentially. In different embodiments, other conditions, such as the fingers' locations as detected, may be used to determine the transmitting sequence of the displacement vectors.

FIG. 7 depicts one example of the transmitting sequence of the fingers' displacement vectors as previously illustrated in FIG. 6. In the present embodiment, the numerals 1, 2 and 3 are the serial numbers assigned to the fingers. In the scanning frame S1, since the displacement vectors of the fingers 1, 2 and 3 need to be transmitted, assuming that each motion information MOTION contains only two displacement vectors, at least two motion informations MOTION have to be transmitted. At this time, the sequence of the fingers' serial numbers is used for transmission. In the scanning frame S2, if it is figured out that finger 3 has the greatest acceleration, finger 3 is regarded as the major finger. As can be seen from FIG. 7, in each following scanning frame, only a single sorted motion information is transmitted, and the displacement vector of finger 3 is preferentially transmitted. Also shown in FIG. 7, in the following scanning frames, each motion information contains the displacement vector of Finger 3. As a whole, the displacement vector of finger 3 (i.e. the major finger) is transmitted more times as compared to all the other fingers. In an application of multi-finger cursor techniques, finger 3 that has the greatest acceleration is regarded as a cursor finger that drives the cursor. With the foregoing transmission method, cursor pause or cursor lag that otherwise might caused by transmitting the numerous displacement vectors of those non-cursor fingers can be prevented.

In one embodiment, the displacement vector contained in the motion information MOTION is expressed by 4 bits, which provide an expressible range of +7˜−8. For the displacement vectors out of this range, the present invention additionally provides an encoding mechanism. Referring to FIG. 3 also, the motion information MOTION further includes a multiple flag N for showing whether the encoding mechanism is implemented.

The finger's actual coordinates are expressed by the equations below:

X, Y Coordinate=Head+R+Δvalue×G (a), N=1

X, Y Coordinate =Head+R+Δvalue (b), N=0

In Equation (a), Δvalue×G+R represents the displacement vector ΔX or ΔY. In Equation (b), Δvalue+R represents the displacement vector ΔX or ΔY. In the present embodiment, the displacement vector in the motion information to be transmitted is Δvalue, which is not necessarily the actual displacement vector ΔX or ΔY. R is the remainder of the displacement vectors not transmitted in the current scanning frame. HEAD represents the head information, and G represents a predetermined multiple. Both the transmitting end and the receiving end (i.e. the host computer) of the information are aware of the value of the predetermined multiple G From the value of the multiple flag N and the displacement vector Δvalue contained in the motion information, the receiving end (i.e. the host computer) can learn about the actual displacement vector the motion information is trying to express. The displacement vector Δvalue is limited to the expressible range of the motion information MOTION. In other words, the value is limited to the maximum bits it expresses.

An example is described herein for illustrating operation of the encoding mechanism. Assuming that the displacement difference ΔX is 43 and the predetermined multiple G is 5, since 43 exceeds the maximum range (7) that can be expressed by the motion information, the multiple flag N is set as 1. According to the quotient relation, 43=7×5+8, and the quotient is 7, meaning that the displacement vector Δvalue in the motion information MOTION is set as 7 and the remainder R representing the displacement vectors that cannot be transmitted in the current scanning frame is 8. The remainder of 8 will be incorporated to the displacement vector generated in the next scanning frame for processing. In the encoding mechanism, the plus sign or minus sign of the displacement vector indicates the direction of the displacement. However, the calculation according to the quotient relation adopts only the absolute value of the displacement vector.

Another example is described for further illustration. Assuming that the displacement vector ΔX is −23 and the predetermined multiple G is still 5, since the displacement vector ΔX exceeds the maximum range (i.e. −8) that can be expressed by the motion information MOTION, the multiple flag N is set as 1. According to the quotient relation, 23=4×5+3, and the quotient is 4, meaning that the displacement vector Δvalue in the motion information MOTION is to be set as −4, and the remainder of 3 will be incorporated to the displacement vector ΔX′ generated in the motion information MOTION of the next scanning frame for processing. In other words, the displacement difference ΔX′−3 will be used as the displacement vector for the next encoding operation.

Briefly, for an excessively large displacement vector of a finger, the present invention uses plural motion informations MOTION to transmit the displacement vectors ΔX and ΔY in a segmented manner, so as to reduce data to be transmitted.

In another embodiment, the multiple flag N is set as 1 or 0 according to a sum of the absolute value of the displacement vector ΔX and the absolute value of ΔY that are expressible in the motion information. For instance, the displacement vector is expressed in 4 bits and in a range of +7=˜−8. Assuming that the actual displacement vector ΔX is 10 and ΔY is −4, when N=1, for ΔX, the value expressible in the motion information is 10 and for ΔY is 0 (because less than 5), and the sum of their respective absolute values is 10. When N=0, the maximum value of ΔX expressible in the motion information is 7 and that of ΔY is −4. The sum of their respective absolute values is 11. Thus the multiple flag N=0.

In the foregoing example, the displacement vectors ΔX and ΔY are expressed by using the common multiple flag N and predetermined multiple G In other embodiments, different multiple flags N and predetermined multiples G may be used to express the displacement vectors ΔX and ΔY, provided the transmitting end and the receiving end (i.e. the host computer) of the motion information have agreement.

Additionally, the method 40 for transmitting coordinates may be realized in various ways. For example, commands, parameters, variables, etc. of a specific programming language may be used to encode the steps of the method 40 into units of program codes PROG that can be stored in a computer-readable medium (such as a memory 720). The program codes PROG are to be read and executed by a processor 710 of a portable electronic device (such as a laptop computer) 700 for providing the steps of the method 40 of the present invention. FIG. 8 schematically shows a useful structure for this purpose.

The steps as described previously are just some steps useful in the embodiments of the present invention and by no means form any limitation to the present invention. Without departing from the spirit of the present invention, people skilled in the art may add intermediary steps to the disclosed methods or integrate some steps of the disclosed methods into one as appropriate. Also, in addition to fingers, the present invention can work with any other objects that can work with a touch device, such as touch pens.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 schematically shows multiple fingers touching a touch device;

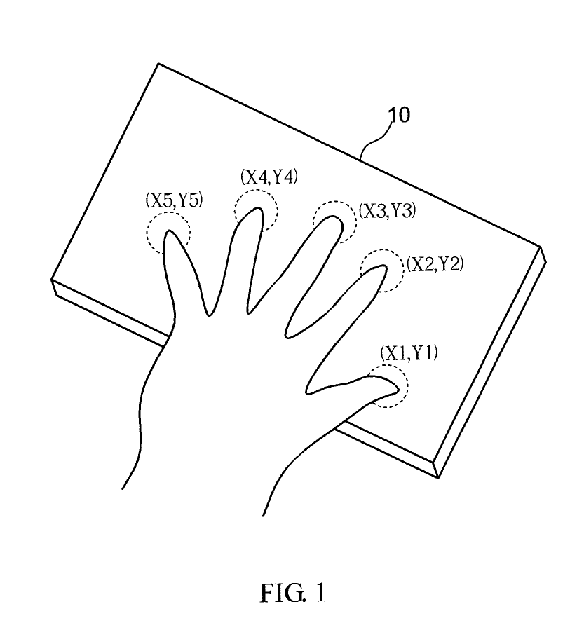

FIG. 2 conceptually shows displacement vectors generated by the fingers touching the touch device of FIG. 1;

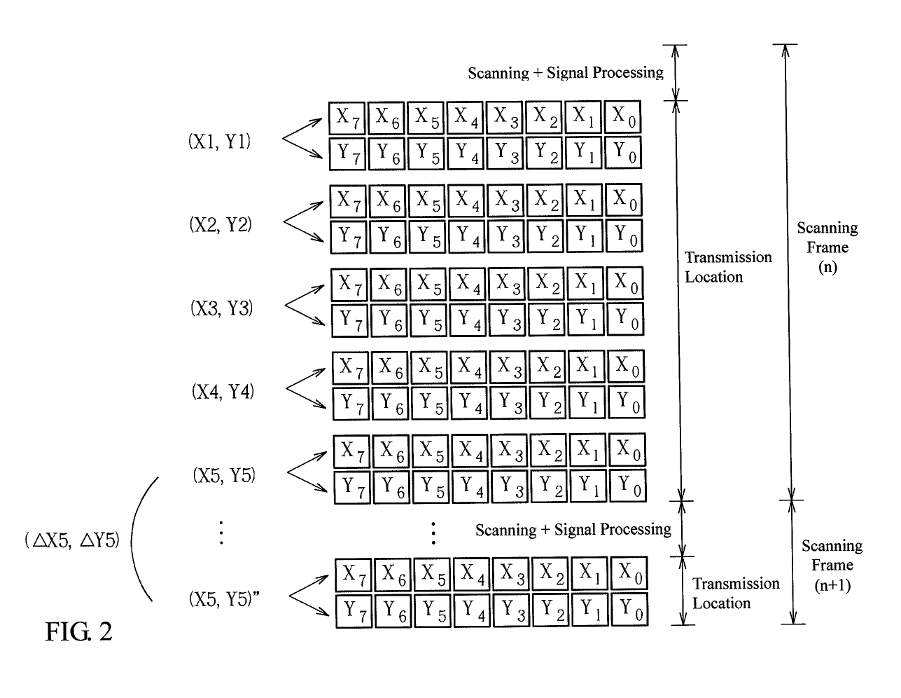

FIG. 3 according to one embodiment of the present invention lists status information, head information and motion information;

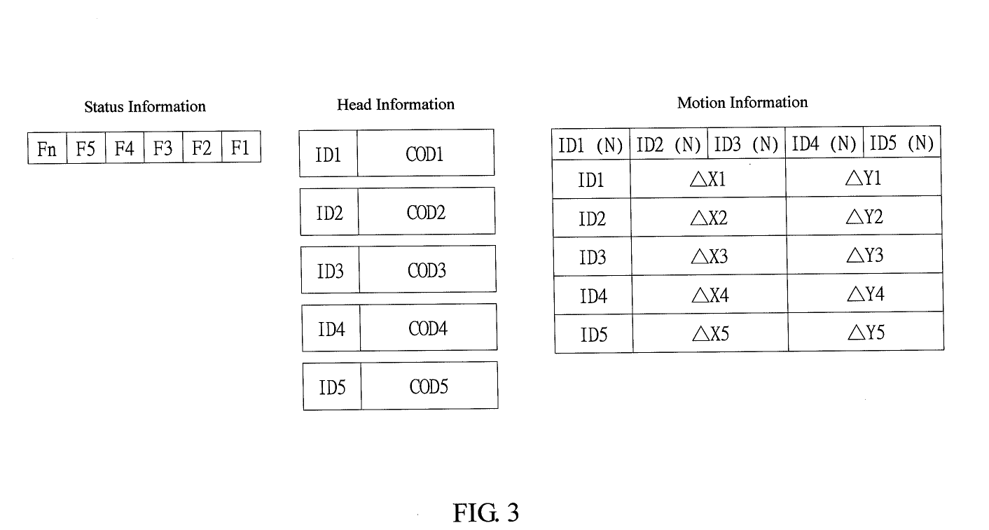

FIG. 4 according to another embodiment of the present invention lists status information, head information and motion information;

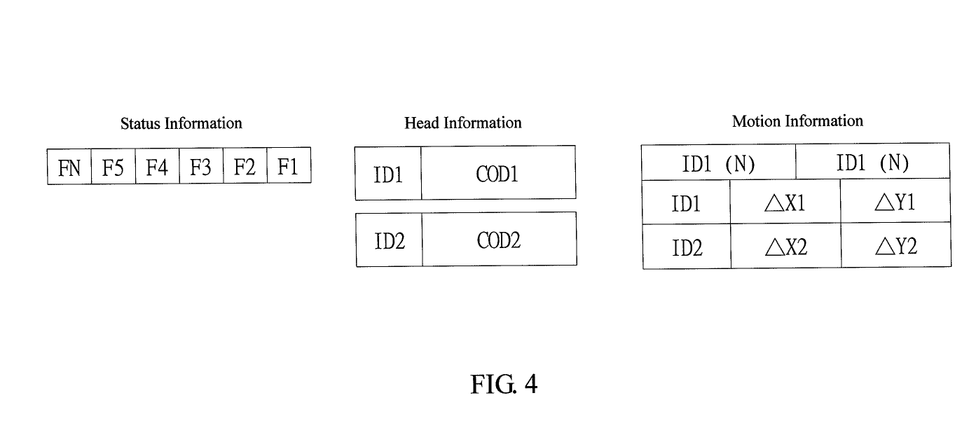

FIG. 5 is a flowchart of a method for transmitting coordinates according to one embodiment of the present invention;

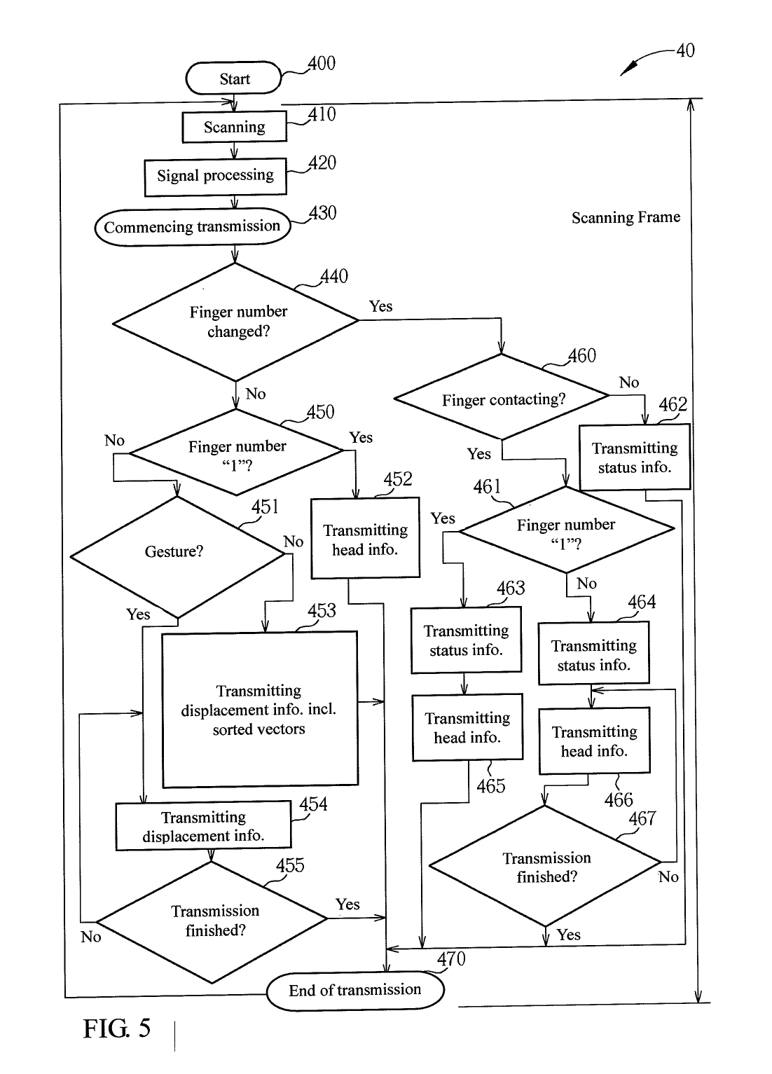

FIG. 6 is a flowchart of a process for transmitting the motion information according to one embodiment of the present invention;

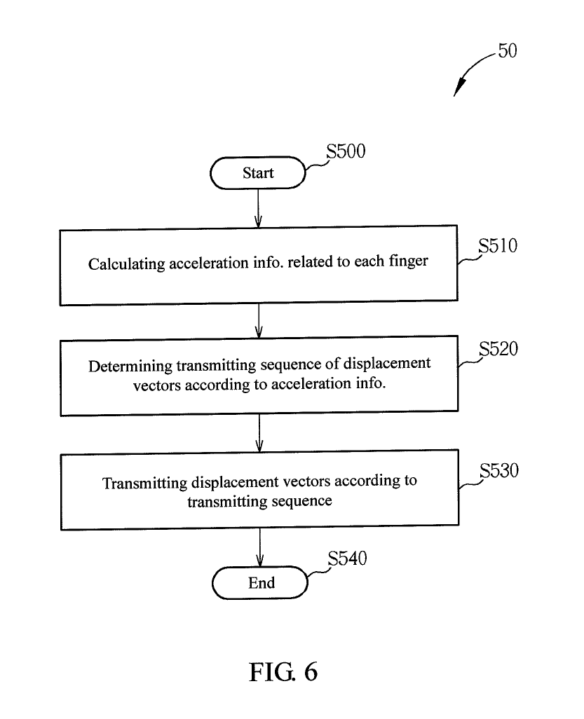

FIG. 7 conceptually shows an exemplificative transmitting sequence of displacement vectors of plural fingers according to FIG. 6; and

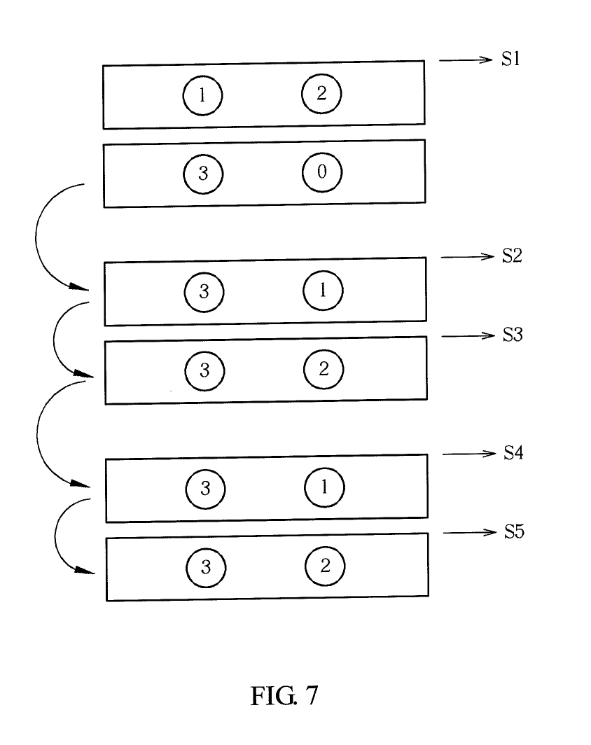

FIG. 8 is a functional block diagram of a portable electronic device using the method for transmitting coordinates as disclosed in the present invention.

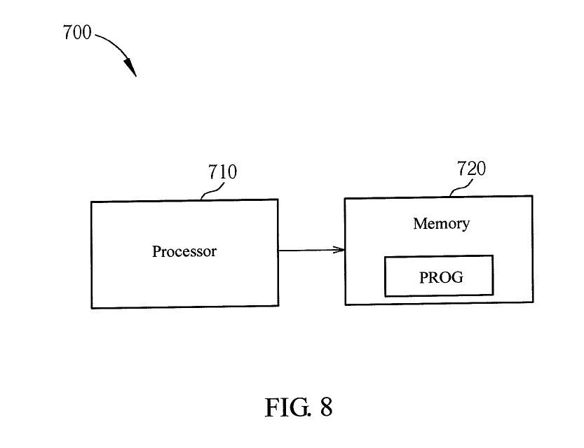

What is claimed is:

1. A method for a touch device to transmit coordinates, comprising steps of:
A.) transmitting a status information when a touching state of the touch device changes, wherein the status information includes a number of objects contacting the touch device;
B.) transmitting a head information when the touch device is operated by a single said object, wherein the head information includes coordinates of the object; and
C.) transmitting a motion information when the touch device is operated by plural said objects and the touching state of the touch device remains unchanged, wherein the motion information includes a displacement vector of at least one said object that moves.

2. The method of claim 1, wherein the step C comprises according to a predetermined time interval, periodically transmitting the displacement vector of at least one of the objects corresponding to the predetermined time interval.

3. The method of claim 1, wherein the step C comprises of:
I.) calculating a first quotient relation between a size of a first displacement vector of one particular said object corresponding to a first time interval and a predetermined multiple, wherein the first quotient relation indicates the size of the first displacement vector as the predetermined multiple multiplied by a first quotient before added by a first remainder; and
II.) transmitting a first displacement vector information of the particular object through the motion information, wherein the first displacement vector information includes the first quotient, the predetermined multiple, and the first remainder.

4. The method of claim 3, wherein the step I is conducted when the size of the first displacement vector exceeds a maximum expressible value allowed by a number of bits of the motion information, and the motion information further comprises a multiple flag for indicating use of the predetermined multiple.

5. The method of claim 3, wherein the step II comprises steps of:
accumulating the first remainder to a second displacement vector of the particular object corresponding to a second time interval, so as to obtain a modified second displacement vector, wherein the second time interval is later than the first time interval;
calculating a second quotient relation between a size of the modified second displacement vector and the predetermined multiple, wherein the second quotient relation indicates the size of the modified second displacement vector as the predetermined multiple multiplied by the second quotient before added by a second remainder, wherein the second quotient relation uses an absolute value for calculation; and
transmitting a second displacement vector information of the particular object through the motion information, wherein the second displacement vector information includes at least a second quotient, and the motion information further comprises a multiple flag for indicating use of the predetermined multiple.

6. The method of claim 1, wherein the step C comprises transmitting a particular displacement vector information including one particular said object through the motion information, wherein the particular displacement vector information includes a particular displacement vector of the particular object corresponding to a particular time interval.

7. The method of claim 1, wherein the step C comprises steps of:
I.) calculating an acceleration information of each said object according to the displacement vectors of the objects;
II.) determining a transmitting sequence of displacement vector informations of the objects according to the acceleration informations corresponding to the objects; and
III.) transmitting the displacement vector informations of the objects according to the transmitting sequence.

8. The method of claim 7, wherein the step II comprises steps of:
in a first time interval, calculating a first distance traveled by each said object according to the displacement vectors; and
in a second time interval, calculating a second distance traveled by each said object according to the displacement vectors, wherein the first time interval and the second time interval are equal in size.

9. The method of claim 7, wherein the transmitting sequence is determined by a descending order of the acceleration informations corresponding to the objects, in which the object has the greatest acceleration information is defined as a major object, and the other object(s) is (are) defined as at least one non-major object.

10. The method of claim 9, wherein the transmitting sequence is such set that the displacement vector of the major object is preferentially transmitted.

11. The method of claim 9, further comprising transmitting the motion information when the acceleration information of the at least one non-major object exceeds a predetermined value.

12. The method of claim 1, wherein the step C comprises steps of:
determining whether a multiple flag is to be used according to a relation between an absolute value of a displacement vector of at least one particular said object corresponding to a time interval and a maximum expressible value allowed by a number of bits of the motion information; and
transmitting a displacement vector information of the at least one particular said object through the motion information, wherein the displacement vector information includes an absolute value of the displacement vector.

13. The method of claim 12, wherein when the absolute value of the displacement vector exceeds the maximum expressible value allowed by the number of bits, the absolute value of the displacement vector is an integral multiple of a predetermined multiple, and the multiple flag is used.

14. The method of claim 12, wherein when the absolute value of the displacement vector does not exceed the maximum expressible value allowed by the number of bits, the absolute value of the displacement vector is remained unchanged.

15. The method of claim 12, wherein when the at least one particular object has at least two displacement vectors, whether the multiple flag is to be used is determined according to a relation between a sum of absolute values of the at least two displacement vectors and the maximum expressible value allowed by the number of bits of the motion information.

16. A computer-readable medium storing a program code so that when the program code is executed by a processor, the processor's performance comprising steps of:
A.) transmitting a status information when a touching state of a touch device changes, wherein the status information includes a number of objects contacting the touch device;
B.) transmitting a head information when the touch device is operated by a single said object, wherein the head information includes coordinates of the object; and
C.) transmitting a motion information when the touch device is operated by plural said objects and the touching state of the touch device remains unchanged, wherein the motion information includes a displacement vector of at least one said object that moves.

17. The computer-readable medium of claim 16, wherein the step C comprises according to a predetermined time interval, periodically transmitting the displacement vector of at least one of the objects corresponding to the predetermined time interval.

18. The computer-readable medium of claim 16, wherein the step C comprises steps of:
I.) calculating a first quotient relation between a size of a first displacement vector of one particular said object corresponding to a first time interval and a predetermined multiple, wherein the first quotient relation indicates the size of the first displacement vector as the predetermined multiple multiplied by a first quotient before added by a first remainder; and
II.) transmitting a first displacement vector information of the particular object through the motion information, wherein the first displacement vector information includes the first quotient and a multiple flag for indicating use of the predetermined multiple.

19. The computer-readable medium of claim 18, wherein the step I is conducted when the size of the first displacement vector exceeds a maximum expressible value allowed by a number of bits of the motion information, and the motion information further comprises a multiple flag for indicating use of the predetermined multiple.

20. The computer-readable medium of claim 18, wherein the step II comprises steps of:
accumulating the first remainder to a second displacement vector of the particular object corresponding to a second time interval, so as to obtain a modified second displacement vector, wherein the second time interval is later than the first time interval;
calculating a second quotient relation between a size of the modified second displacement vector and the predetermined multiple, wherein the second quotient relation indicates the size of the modified second displacement vector as the predetermined multiple multiplied by the second quotient before added by a second remainder, wherein the second quotient relation uses an absolute value for calculation; and
transmitting a second displacement vector information of the particular object through the motion information, wherein the second displacement vector information includes at least a second quotient, and the motion information further comprises a multiple flag for indicating use of the predetermined multiple.

21. The computer-readable medium of claim 16, wherein the step C comprises transmitting a particular displacement vector information including one particular said object through the motion information, wherein the particular displacement vector information includes a particular displacement vector of the particular object corresponding to a particular time interval.

22. The computer-readable medium of claim 16, further comprising steps of:
defining the objects as a major object and at least one non-major object, and a transmitting sequence of displacement vectors of the objects according to a predetermined condition.

23. The computer-readable medium of claim 22, wherein the predetermined condition is subject to acceleration informations related to movements of the objects, and the object having a greatest acceleration is defined as the major object.

24. The computer-readable medium of claim 22, wherein the transmitting sequence is such set that the displacement vector of the major object is preferentially transmitted.

25. The computer-readable medium of claim 22, further comprising transmitting the motion information when the acceleration information of the at least one non-major object exceeds a predetermined value.

26. The computer-readable medium of claim 16, wherein the step C comprises steps of:
determining whether a multiple flag is to be used according to a relation between an absolute value of a displacement vector of at least one particular said object corresponding to a time interval and a maximum expressible value allowed by a number of bits of the motion information; and
transmitting a displacement vector information of the at least one particular said object through the motion information, wherein the displacement vector information includes an absolute value of the displacement vector.

27. The computer-readable medium of claim 26, wherein when the absolute value of the displacement vector exceeds the maximum expressible value allowed by the number of bits, the absolute value of the displacement vector is an integral multiple of a predetermined multiple, and the multiple flag is used.

28. The computer-readable medium of claim 26, wherein when the absolute value of the displacement vector does not exceed the maximum expressible value allowed by the number of bits, the absolute value of the displacement vector remains unchanged.

29. The computer-readable medium of claim 26, wherein when the at least one particular object has at least two displacement vectors, whether the multiple flag is to be used is determined according to a relation between a sum of absolute values of the at least two displacement vectors the maximum expressible value allowed by the number of bits of the motion information.

30. A method for a touch device to transmit coordinates, the method comprising steps of:
A.) using the touch device to detect plural objects so as to obtain a contact information about how the objects contact the touch device;
B.) obtaining initial coordinates respectively corresponding to contact locations of the objects according to the contact information;
C.) transmitting the initial coordinates;
D.) obtaining displacement vectors respectively corresponding to movements of the objects; and
E.) transmitting the displacement vectors.

31. The method of claim 30, wherein the displacement vectors and the initial coordinates are for providing a host computer with contact locations of the objects on the touch device.

32. The method of claim 30, wherein the step D comprises dividing the displacement vectors by a predetermined multiple, so as to obtain first quotients and first remainders respectively corresponding to the displacement vectors.

33. The method of claim 32, wherein the plural first remainders are incorporated into displacement vectors corresponding to next movements of the objects for transmission.

34. The method of claim 30, further comprising determining a transmitting sequence of the displacement vectors according to an acceleration information related to movement of each said object.

35. A method for a touch device to transmit displacement vectors, the displacement vectors respectively corresponding to objects contacting the touch device, and the method comprising steps of:
defining the objects as a major object and at least one non-major object according to a predetermined condition; and
only transmitting the displacement vector of the major object.

36. The method of claim 35, wherein the predetermined condition is subject to acceleration informations related to movements of the objects, and the object having a greatest acceleration is defined as the major object.

37. The method of claim 36, wherein the displacement vector of the major object is transmitted earlier than the displacement vector of the at least one non-major object.

38. A computer-readable medium storing a program code, so that when the program code is executed by a processor, the processor's performance comprising steps of:
A.) using a touch device to detect objects so as to obtain a contact information about how the objects contact the touch device;
B.) obtaining initial coordinates respectively corresponding to contact locations of the objects according to the contact information;
C.) transmitting the initial coordinates;
D.) obtaining displacement vectors respectively corresponding to movements of the objects; and
E.) transmitting the displacement vectors.

39. The computer-readable medium of claim 38, wherein the displacement vectors and the initial coordinates are for providing a host computer with contact locations of the objects on the touch device.

40. The computer-readable medium of claim 38, wherein the step D comprises dividing the displacement vectors by a predetermined multiple, so as to obtain first quotients and first remainders respectively corresponding to the displacement vectors.

41. The computer-readable medium of claim 40, wherein the plural first remainders are incorporated into displacement vectors corresponding to next movements of the objects for transmission.

42. The computer-readable medium of claim 38, further comprising determining a transmitting sequence of the displacement vectors according to an acceleration information related to movement of each said object.

43. The computer-readable medium of claim 38, further comprising defining the object as a major object and at least one non-major object according to a predetermined condition.

44. The computer-readable medium of claim 43, wherein the predetermined condition is subject to acceleration informations related to movements of the objects, and the object having a greatest acceleration is defined as the major object.

45. The computer-readable medium of claim 44, wherein the displacement vector of the major object is transmitted earlier than the displacement vector of the at least one non-major object.
